(19) United States
(12) Patent Application Publication
(10) Pub. No.: US 2021/0294661 A1
(43) Pub. Date: Sep. 23, 2021

(54) TASK MANAGEMENT OF LARGE COMPUTING WORKLOADS in A CLOUD SERVICE AGGREGATED FROM DISPARATE, RESOURCE-LIMITED, PRIVATELY CONTROLLED SERVER FARMS

(71) Applicant: Entertainment Technologists, Inc., Altadena, CA (US)

(72) Inventor: Mark Turner, Altadena, CA (US)

(21) Appl. No.: 17/206,220

(22) Filed: Mar. 19, 2021

Related U.S. Application Data
(60) Provisional application No. 62/991,731, filed on Mar. 19, 2020.

(51) Int. Cl. G06F 9/50; H04L 29/08; G06F 9/48; G06F 9/46; G06Q 30/02; G06Q 30/08

(52) U.S. Cl. CPC G06F 9/5038; H04L 67/10; G06F 9/4881; G06F 9/485; G06F 2209/503; G06Q 30/0283; G06Q 30/08; H04L 67/12; G06F 2209/508; G06F 9/461

(57) ABSTRACT

A cloud service is aggregated from private server farms for the purpose of large computational jobs such as rendering the computer graphics scenes in movies. This cloud service faces unique challenges because its private server farms have nonhomogeneous resources, capacity that may fluctuate, and resource constraints. Clients submit jobs that come labelled with Quality of Service information that may include a priority. Then a Global Task Manager efficiently assigns jobs to servers based on this Quality of Service information, and mediates the jobs being submitted and the results being returned back to the client. Jobs may be given deadlines or resource constraints for the Global Task Manager to optimize. Clients may make price bids that the Global Task Manager negotiates with the private server farms owners. The Global Task Manager may be allowed to preempt jobs from their assigned place in the processing queue, when necessary. Clients and private server farm owners may be given administrative interfaces to adjust their stated Quality of Service and other constraints.

### BACKGROUND

A cloud service provider is an owner of hardware computer resources that offers these resources to third parties, clients, over the Internet. These resources may include data storage, computation, specialized machines with high-efficiency characteristics such as Graphics Processor Units (GPUs), server farms with lower efficiency at a lower cost, physical security, and cyber security protection.

For a client with small computational resource needs, the marginal cost of cloud services far outweighs the expensive capital costs of buying their own hardware and data centers.

However, some industries have large computational resource needs. For example, computer graphics in the media and entertainment industry is computationally intensive. Artists who create a scene in a movie with 3D modeling tools want to see what it would look like in the finished film, as quickly as possible, so that they can iteratively refine and then finalize their work. But rendering a single movie frame can take more than a day. The energy industry also uses large computations to guide the exploration for new oil and gas resources. A single seismic survey can result in millions of Gigabytes of data that must be turned into a useful model of the Earth's subsurface, to avoid drilling in the wrong place.

A client with large computational needs can actually save money by purchasing and operating their own computing resources, instead of paying cloud service providers a marked-up price to do so. The marginal costs saved by such a client, in such a large volume of computation, outweigh the capital costs of purchasing and housing the hardware.

Also, a client with a wholly owned server farm can optimize its hardware and software to its specialized purpose. For example, in the film industry, you would ideally like to upload art assets such as 3D models just once, and then render frames as many times as needed. Cloud services do offer persistent resources, but expensively. To use cloud services inexpensively, you must upload art assets before every computing session, because when each frame rendering session is over, the cloud server resets, wiping the art assets from storage.

Unfortunately, clients with large computational needs, who own their own computing resources, often have periods of high demand and low demand that don't match their in-house resources. For example, a typical film studio is only using its in-house server farm 60% of the time. Sometimes, the hardware is idle, a waste of resources. Sometimes, additional capacity is needed, and the client must use generic public cloud services, despite their higher marginal cost and lack of specialized, industry-specific resources.

A solution is needed for an industry with large computation needs, where several clients have privately owned hardware resources, to share these resources efficiently. Their disparate server farms could be collected into a single aggregated cloud resource.

This presents many challenges, including but not limited to:
Each server farm in the aggregated cloud service has limited capacity and differing capabilities, and thus a task manager is needed to efficiently match computational jobs to the best-fitting server resources, and prioritize computational jobs against each other.
With each server farm being privately owned, its available capacity will vary as its owner either does or does not make use of it, including a potential immediate interruption to others of all available capacity.
The computational jobs sent to the aggregated cloud service come with differing estimated usage of various hardware resources, different requested time-to-completion, and differing requested quality of service, which must be efficiently mediated.

### PROBLEMS WITH THE PRIOR ART

Cloud computing is a massive industry, but much of its prior art does not recognize the problems for which the present invention provides a unique solution.

Many prior art approaches concern scheduling large computational computer graphics rendering jobs on only a single cloud service, not an aggregate of privately owned server farms. For example, US20080080396A1: Marketplace for cloud services resources relates to dividing up and selling access to portions of a single cloud service. Other patent documents, such as US20140237373A1: Method of provisioning a cloud-based render farm, U.S. Pat. No. 9,384,517B2: Rendering, and US20160147783A1: Repository-based data caching apparatus for cloud render farm and method thereof, focus on very specific issues unique to the media and entertainment industry, such as persistent storage.

The prior systems that do aggregate cloud services for the most part assume that these cloud computing resources are infinite, and therefore there's no need for task management, or prioritization, or scheduling. They also assume that cloud services machines are homogenous, making it irrelevant which individual server handles which job. They do not comment upon an aggregate cloud service made from private server farms, which necessarily has limited resources, disparate server machines with differing capabilities, and available capacity that may fluctuate unexpectedly.

These include U.S. Pat. No. 9,348,652B2: Multi-tenant-cloud-aggregation and application-support system, and US20140006581A1: Multiple-cloud-computing-facility aggegation, which relate primarily to the migration of jobs from one cloud service to another, and U.S. Pat. No. 8,954,564B2: Cross-cloud vendor mapping service in cloud marketplace and US20130066940A1: Cloud service broker, cloud computing method and cloud system which envision unified user interfaces for monitoring jobs across disparate cloud services.

The technical term “Quality of Service” refers to a protocol for clients and services to communicate expectations about how to prioritize and handle client requests. The term originated in the field of networking, where a client could send an Internet packet that is part of an Internet phone call (VoIP). So that the call does not drop, VoIP Internet packets are far more important than email message Internet packets, which do not require real-time network transmission. To indicate this, the client annotates the Internet packet with a Quality of Service statement requiring low latency and high priority transmission. The service uses this Quality of Service information to prioritize and handle Internet packets. If the requested Quality of Service is not possible, the service and client can communicate about the failure. In one example, U.S. Pat. No. 9,338,223: Private cloud topology management system enforces Quality of Service for traffic in the cloud; receive policies for determining optimum routes to the cloud from an administration device; apply the policies to the network topological information from the devices, the network performance data, the service topological information, and the service performance data to obtain routing rules; and forward the optimized routing rules to a set of request routers.

As a method of communicating expectations between a client and a service, Quality of Service technology is rarely applied outside of networking to annotate very long cloud computations. This may be perhaps because public cloud services are generally assumed to have infinite capacity, and thus typically have no resource constraints to prioritize. Also, private server farms are invariable wholly owned, and thus all jobs assigned to private server farms come from the same entity.

U.S. Pat. No. 8,464,255B2: Managing performance interference effects on cloud computing servers describes a method of receiving indications of threshold levels of quality of service to maintain for each of a plurality of virtual machines operated by multiple customers sharing computing resources. Quality of service is affected by interference caused by the need for a plurality of virtual machines to share the available computing resources on for example, a single server. The method also includes of dynamically allocating computing resources amongst the plurality of virtual machines to maintain levels of quality of service for each of the plurality of virtual machines at or above the threshold levels of quality of service. Focusing primarily on a group of virtual machines that compete for shared resources doesn't contemplate handle disparate, nonhomogeneous private server farms or the particular issues that arise in the context of large compute jobs for the computer graphics applications.

Finally, US20180321971A1: Systems, methods and apparatus for implementing a scalable scheduler with heteroeneous resource allocation of large competing workloads types using qos, describes systems, methods, and apparatuses for implementing a scalable scheduler with heterogeneous resource allocation of large competing workloads using Quality of Service (QoS) requirements. A scheduling service includes a compute resource discovery engine to identify a plurality of computing resources available to execute tasks, the computing resources residing within any one of private or public datacenters or third party computing clouds and a plurality of resource characteristics for each of the plurality of computing resources. A workload discovery engine identifies pending workload tasks to be scheduled for execution from one or more workload queues. A policy engine identifies a Service Level Target (SLT) for each of the workload tasks so identified; and a scheduler schedules each workload task for execution via one of the computing resources available based on which of the computing resources are estimated to meet the SLT.

However the approach described therein does not contemplate the aforementioned needs of an aggregate cloud service made from private server farms, which necessarily has limited resources, disparate server machines with differing capabilities, and available capacity that may fluctuate immediately and unexpectedly. Furthermore, the above prior art does not contemplate a task manager that not only locates available resources, but which efficiently matches jobs to the “best-fitting” server resources, for example, assigned jobs to resources based on the types of computations needed.

### SUMMARY

The present invention aggregates private server farms into a unified cloud-like service intended for large computing jobs. A centralized Global Task Manager continually polls each private server farm for the available capacity of various aspects of its hardware installation, receives job requests from clients, delegates jobs to the private server farms, monitors those jobs, and communicates back to the clients.

Communications between clients and the Global Task Manager utilize a specialized Quality of Service protocol, which allows requests to be made and expectations to be set about priorities, resource needs, and estimated time-to-completion. The Global Task Manager uses an algorithm to efficiently delegate jobs based on those Quality of Service constraints, aiming to complete jobs quickly while making most efficient use of the available capacity of each private server farm.

As capacity changes, job requests arrive, jobs are completed, or a client changes or cancels a job request, the Global Task Manager strives to optimize computation. Occasionally a job in progress will be preempted for the efficiency of the system as a whole. When capacity is filled, the Global Task Manager will make decisions about delegating jobs to generic, public cloud services. In specific industries, jobs may be broken into subjobs, and jobs or subjobs may have resource dependencies on each other, which the Global Task Manager would take into account.

Some of the objectives and advantages of this approach include:
Providing an income to private entities who took on the infrastructure costs of building their own server farm and have occasional spare capacity.
Completing high-capacity jobs quickly for clients who have insufficient private resources,
Providing services at a lower price than generic public cloud services, by making use of existing, spare industry capacity, and more efficiently, if this industry's private server farms have resources specialized to industry computations.
Allowing clients and the aggregate cloud service to have nuanced communication about expectations, capabilities, success, failure, and gradations of success and failure, which may include but is not limited to priorities, pricing, resource requirements, and timing.
Efficiently assigning large computing jobs to maximize each job meeting its Quality of Service requirements.

In one implementation, the Global Task Manager mediates payments between clients and the private server farms. These payments may be discounted if the Quality of Service requirements are not met.

In another implementation, the Global Task Manager mediates payment bidding between the clients submitting jobs and the private server farms that comprise the aggregate cloud service.

In another implementation, the Global Task Manager mediates client requests for future resources, scheduling and reserving such resources in advance and at a set price.

In another implementation, the Global Task Manager mediates whether the private owner of each private server farm must guarantee some level of capacity available to third parties on a set schedule, or are permitted to reduce available capacity without notice, even if third party jobs in progress must be halted (“preempted”). In a pricing system, private server farms that unexpectedly reduce their promised capacity may be subject to financial penalties.

In another implementation, the Global Task Manager's job assignment optimizations may take into account a server-side capability to halt a job in mid-process, migrate it elsewhere, and restart it.

The resulting technical challenges are then:
a) What is the best protocol to communicate Quality of Service information?
b) What is the best way to prioritize and delegate jobs to fit constrained resources?
c) What is the best way to break up a divisible job into subjobs?
d) What is the best way to allow clients to change the Quality of Service while a job is running, and to allow private server farms to change their available resources while a job is running?
e) What is the best way to automatically set pricing, when given parameters set by the client and each private server farm, resource constraints, and a job's desired Quality of Service?

These problems are solved with a method and system according to a preferred embodiment in the following way:
a) Quality of Service is communicated:
   From the client to the Global Task Manager with each job request with fields including Job Start Time, Job Required End Time, Job Priority Level, and estimated resource usage along various dimensions.
   From a private server farm to the Global Task Manager with its resource capacity along various dimensions, and optionally as scheduled through future time.
b) Any multilevel queuing algorithm can be used. For example:
   1. Create a job queue for each server in every private server farm. Initially these queues are empty.
   2. Categorize the jobs by priority, as designated in each job's Quality of Service information.
   3. Use a priority-based deficit weighted round robin algorithm to select which job J from which priority category PC is next to get assigned to a server. It is a “fairer” system that allows lower priority jobs to occasionally get selected, so that the highest priority jobs don't dominate, forever starving other priority jobs of attention.
   4. Make a list of all the servers on all the private server farms and their current capacities.
   5. Remove the servers from the list that don't matches the resource constraints required by the Job J.
   6. From the list, choose the Server S that will finish Job J the fastest, based on Job J's estimated time to complete with Server S's resources, and the jobs ahead of Job J in Server S's work queue.
   7. Add J to the work queue WQ for server S.
   8. If the estimated time of completion of J is past its Quality of Service requested time, then either respond to the client with a, or attempt to force J onto a server by preempting a lower priority job K that was chosen out of “fairness” in Step 3.
   9. Go back to Step 3 and choose the next job J for assignment.
   10. When a new job arrives from a client, recompute all the job assignments to re-optimize meeting each active job's Quality of Service.
c) Break every job up into its subjobs. Then use any multilevel queuing algorithm, as in (b). If there are efficiencies to grouping sibling subjobs together on the same private server farm, then this becomes an additional constraint when assigning jobs to servers in step (b)5.
d) When a change occurs, clear out the work queues WQ on every server, except for the currently running jobs. Reassign all the remaining jobs as in algorithm (b) above, which will sometimes preempt a currently running job.
e) Modify algorithm (b) above in the following manner:
   When categorizing jobs into priority categories PC, use the maximum price each job is willing to pay as the prioritization metric.
   A Job J with Price Range JPR is never assigned to a Server with a price range SPR if the maximum value of JPR is lower than the minimum value of SPR.
   Once all jobs have been assigned to servers, calculate price by sorting all the jobs by priority. Then for each Job J from lowest priority to highest priority, the price it pays is whichever is greater:
      i. The minimum payment required by the server S that Job J is assigned to.
      ii. One penny (or some other increment) more than the Job K that is just lower in priority.

### BRIEF DESCRIPTION OF THE DRAWINGS

The foregoing and other features, and advantages will be apparent from the following more particular description of preferred embodiments, as illustrated in the accompanying drawings in which like reference characters refer to the same parts throughout the different views.

FIG. 1 shows a system for task management of large computing workloads over disparate, resource-limited, privately controlled server farms.

FIG. 2 shows an example protocol for communicating Quality of Service.

FIGS. 3A and 3B show an example of a multilevel queuing algorithm

FIG. 4 shows an example of deciding whether to preempt a job.

FIG. 5 shows an example of setting prices in a bidding system.

### DETAILED DESCRIPTION OF PREFERRED EMBODIMENTS

A description of preferred embodiments follows.

### Global Task Manager Assigns Client Jobs to Private Server Farms

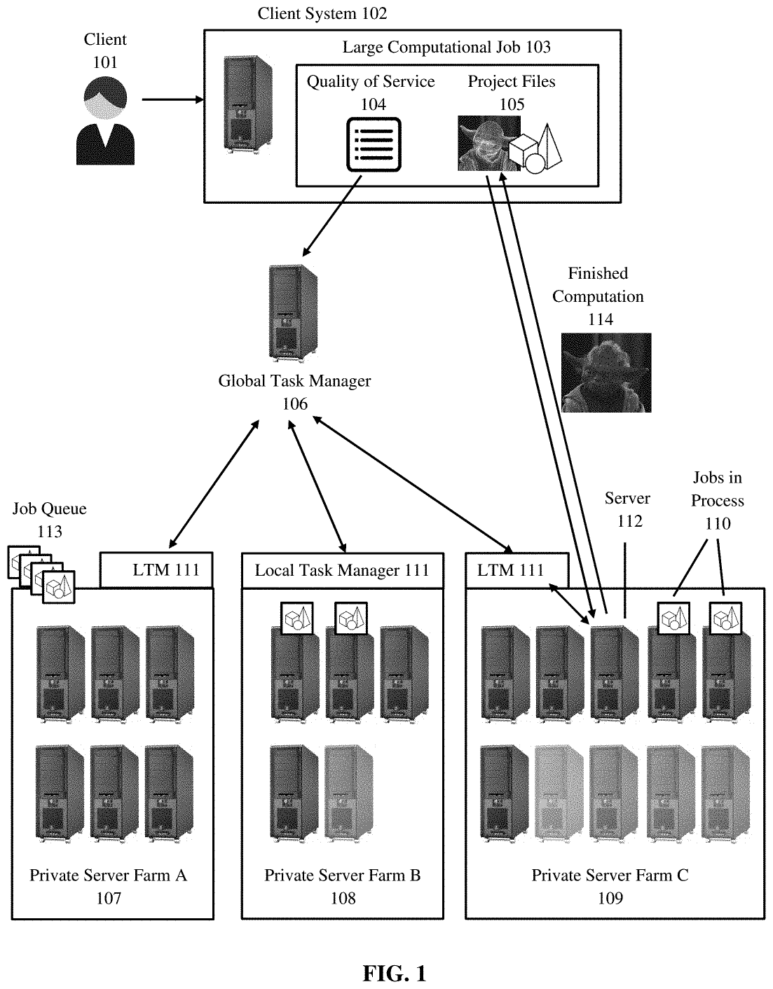

FIG. 1 shows the system architecture for how a Global Task Manager assigns client jobs efficiently to private server farms. For this invention, we assume the existence of a Client System 102 and one or more Private Server Farms 107, 108, 109. This invention resides in the configuration and algorithms in the Global Task Manager 106 and the Local Task Managers 111.

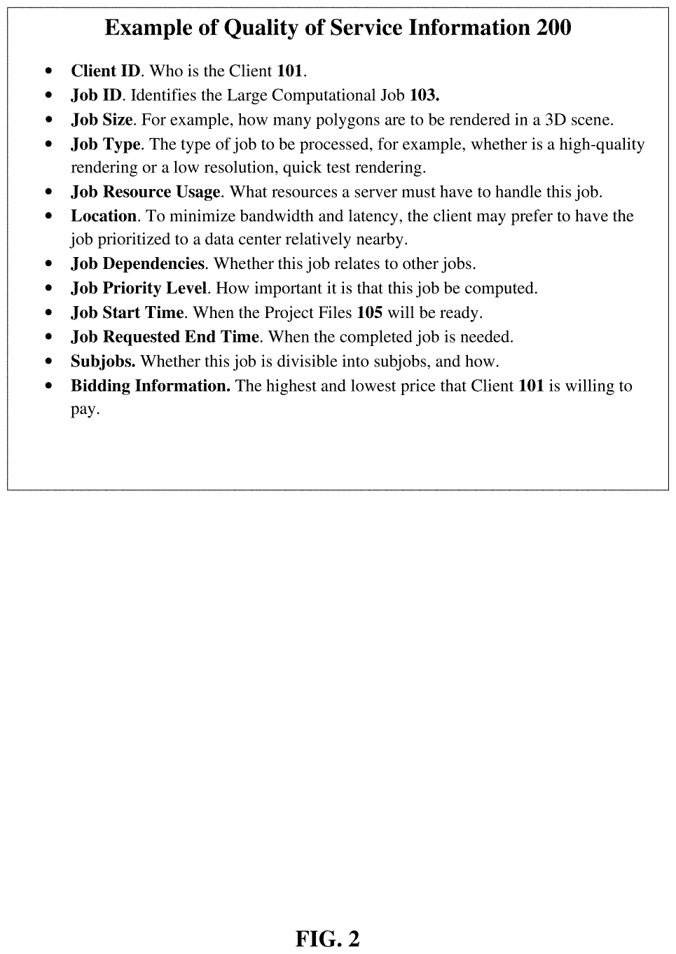

Client 101 runs a Client System 102 where a Large Computational Job 103 is defined, including Project Files 105 and a Quality of Service 104 description. For example, in the media and entertainment industry, an artist might craft 3D models that comprise an animated movie scene. The Project Files 105 would be those 3D models and the Quality of Service 104 would assign the job a priority and a “size” estimate of resource usage relating to the number of polygons and light sources in the scene. See FIG. 2. for more on the Quality of Service protocol for computational jobs.

The Client System 102 submits a job, described by its Quality of Service 104, to the Global Task Manager 106. The Global Task Manager 106 frequently polls each Local Task Managers 111 in each Private Server Farm 107, 108, 109. The Local Task Manager 111 gathers data and is in charge of estimating:
The resource capacity of each Private Server Farm 107, 108, 109, which could include but is not limited to storage space, RAM, CPU/GPU, and specialized systems (depicted in purple, green, and blue).
Any currently executing Jobs in Process 110, whether they have crashed, hung, or are proceeding normally, an estimated time to completion, and estimated future resource usage. If the owner of the private server farm has made capacity guarantees, these guarantees may follow a set future schedule to be taken into account.
How the Quality of Service 104's estimate of resource usage and applies specifically to the processors in the Private Server Farm that it manages, and an estimated time to complete the Large Computational Job 103.

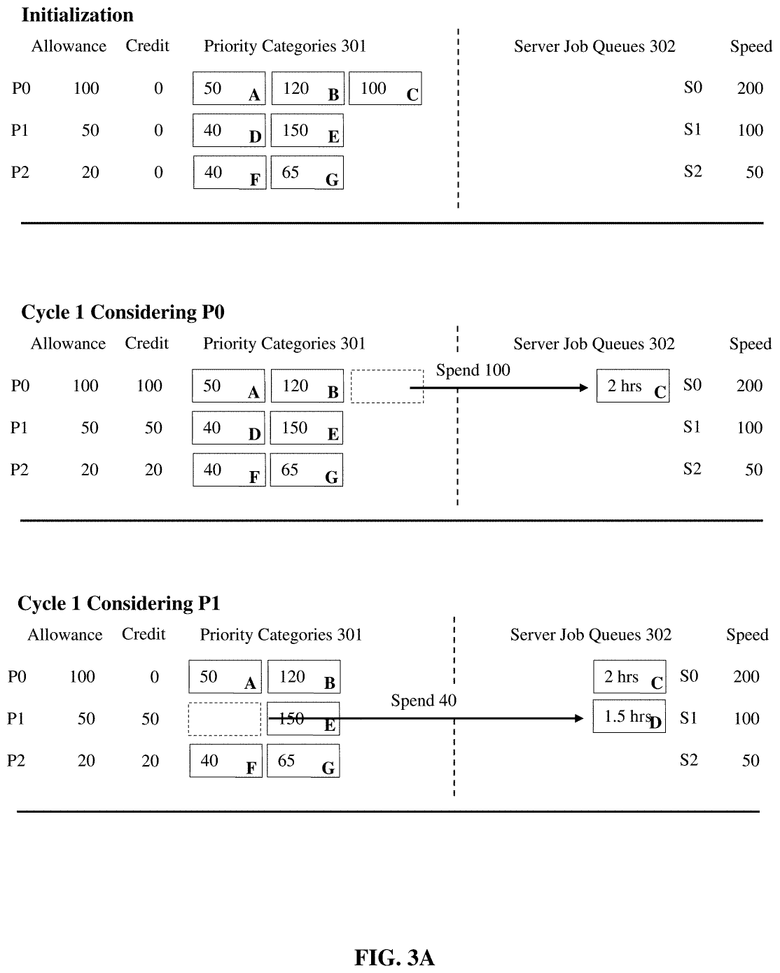

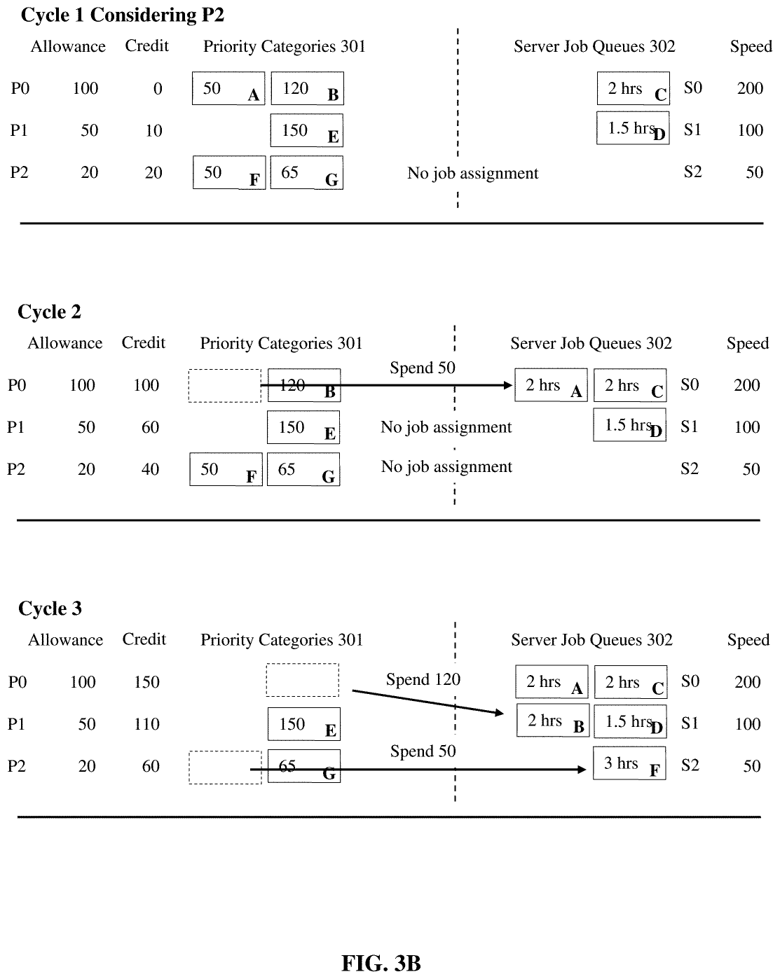

The Local Task Manager 111 reports this information back to the Global Task Manager 106. Based on this information, the Global Task Manager 106 designates a Server 112 that the Large Computational Job 103 will be assigned to. See FIG. 3 for an example of how this decision is made, and the factors involved, which may include optimizing the Large Computational Job 103 to go to Private Server Farm with the lowest processing cost, best-matched resource capacity, or the lowest cost network transmission route (typically, the physically nearest Private Server Farm).

In one implementation, each CPU in the Private Server Farms 107, 108, 109 has a Job Queue 113, where multiple different jobs are assigned to be processed sequentially, in a given queue order. In another implementation, the Global Task Manager 106 may break a Large Computational Job 103 into subjobs that can be processed independently.

In one implementation, the Global Task Manager 106 determines a price and estimated time of completion, and confirms that with Client 101, who must accept these terms before the job is formally assigned. In another implementation, terms that are acceptable to Client 101 are already packaged into the Quality of Service 104 description and thus no explicit confirmation is required.

Acting through the Local Task Manager 111, the Global Task Manager 106 instructs Server 112 to request the Large Computational Job 103's Project Files 105 from the Client System 102. The Global Task Manager 106 also tells the Client System 102 to be ready to receive such a request.

When Server 112 is ready to process the Large Computational Job 103, either immediately or because Large Computational Job 103 has finally reached the front of the queue, making it next to go, Server 112 contacts Client System 102 and requests the Project Files 105. In one implementation, if multiple jobs rely on the same project files, then they need only be transmitted once to each Private Server Farm running one of those jobs. For example, in media and entertainment, the Project Files 105 relating to Yoda's 3D models remain the same throughout the entire movie, no matter which computer graphics scene job is being rendered.

Server 112 performs the computation, watched over by the Local Task Manager 111 for progress, estimated time to completion, and job crashes, hangs, overuse of resources, or other failure states. In one implementation, Client 101 can, during processing of Large Computational Job 103, either manually or automatically cancel the job, request a lower priority (and perhaps win a lower price or more resources for another of its jobs), or request a higher priority (and perhaps being forced to accept a higher price).

When the computation is complete, Server 112 sends the Finished Computation 114, for example, the fully rendered movie scene with Yoda, back to the Client System 102. The Local Task Manager 111 informs the Global Task Manager 106 about this success, and the Client System 102 confirms successful receipt of the Finished Computation 114. The Global Task Manager 106 may then invoice the Client 101 for the successful computation.

### Communicating Quality of Service

FIG. 2 shows one example of what a Quality of Service request could look like.
Client ID. Specifies which Client 101 owns the job and will make a payment. The Client data object may also contain information such as:
   The IP address of the Client System 102 and access credentials.
   Client contact information
   Client billing information and history of computed jobs
Job ID. An identification number for the Large Computational Job 103.
Job Size and Job Type assist the Global Task Manager 106 to estimate the time needed to process Large Computational Job 103 on various Private Server Farm 107, 108, 109 Servers 112. A Job Type could describe the quality of the results being calculated. For example, in the entertainment industry the Job Type could describe rendering a movie scene in low-quality for testing, medium-quality, or high-quality with a radiosity approach and a large number of pixels suitable for the final film. Or a Job Type could describe a type of computation. In the oil and gas exploration industry, algorithms include Kirchhoff migration, Wave-equation migration, Reverse-time migration, and Full-wavefield inversion, all methods of analyzing seismic data.
Job Resource Usage assist the Global Task Manager 106 to rule out possible Servers 112 that simply don't have the resources, e.g. RAM or a GPU, to compute this job. Job Resource Usage would also include information about the bandwidth and storage needed to transmit Project Files 105.
Location. The Global Task Manager 106 could use this to prioritize servers located in a data center relatively nearby to the Client 101, thus reducing bandwidth and latency issues of transmission.
Job Dependencies for example would include:
   Whether this job must be completed before or after some other job. The Global Task Manager 106 would use this to compute priorities.
   Whether this job shares Project Files 105 with other jobs. The Global Task Manager 106 would use this to group associated jobs onto the same Private Server Farm 109, reducing the need to transmit Project Files 105 to multiple Private Server Farms 107, 108, 109.
Job Priority Level helps the Global Task Manager 106 make decisions about prioritizing the Large Computational Job 103. Often, the priority level of a job is directly related to the price that Client 101 pays. The Job Priority Level may indicate whether the job may be preempted or must be guaranteed to keep its place in the work queue.
Job Start Time and Job Requested End Time are the calendar date and time that a job can be started and that a job should be finished. These help the Global Task Manager 106 to confirm that the Job Priority Level is set correctly. If the job cannot be processed by the Job Requested End Time at the given Job Priority Level, the Client 101 must authorize a higher priority. Conversely, if the job can be processed readily at a lower Job Priority Level, the Global Task Manager 106 may want to inform Client 101 that a lower price may be paid.
Subjobs. If it is possible to compute portions of the Large Computational Job 103 independently, this field describes how this Large Computational Job 103 may be broken into subjobs, and how those subjobs are reassembled. Computing subjobs in parallel will generally speed up the overall completion of the Large Computational Job 103. For example, in media and entertainment, each frame of a movie scene can usually be processed separately from the other frames. Each subjob may have its own Quality of Service information, such as Job Size, Job Type, Job Resource Usage, and Job Dependencies. However subjobs cannot have different Job Priority Level, Job Start Time, or Job Requested End Time.
Bidding Information. A price range that helps the Global Task Manager 106 automatically find the right priority and lowest possible price that gets the Large Computational Job 103 completed satisfactorily. The Quality of Service information for a job could include the highest price that Client 101 is willing to pay, or a graded scale for how much Client 101 is willing to pay for faster computation, or willing to delay computation for a lower price. The Quality of Service information for each server could include a minimum price acceptable to receive a job, or a graded scale—for example, server resources that the owner of the private server farm prefers to reserve for itself may become available in exchange for a higher client payment.

### Preferred Implementation of a Multilevel Queuing Algorithm

FIG. 3 shows how the Global Task Manager 106 assigns multiple jobs to multiple servers. Although this invention could be implemented with any queuing algorithm, this preferred implementation is a modified multilevel queuing algorithm based on a deficit weighted round robin approach. It is based on the following cycle:
1. Each cycle, select some job from some priority category and assign it to some server queue.
2. Go back to Step 1 until all jobs are assigned.

Initialization

On the right side are the Server Job Queues 302, which are currently empty. No server has been assigned to compute any job yet. Of course, there could be any number of servers and server queues.

Servers are assigned a speed. Each speed can be assigned manually, or automatically using a scoring system that combines CPU speed and other measures of resource capacity. In this example, Server 0 is very fast and has been assigned a speed of 200. Server 1 is not quite as fast and has been given a speed of 100. Server 2 has a CPU that is just as fast, but it has less RAM, which can hinder computation, so it is given only a speed of 50.

On the left of FIG. 3, take all the jobs A, B, C, D, E, F, G requested by various clients and categorize them by priority into the Priority Job Categories 301. For example, jobs A, B, and C each have a Quality of Service marking them Priority 0, the most urgent priority. Jobs D and E are filed into Priority 1, which is less urgent, and Jobs F and G are filed into Priority 2, the least urgent. Of course, there could be any number of priority categories.

An implementation of this invention could employ a “priority queuing algorithm”, where all the Priority 0 jobs must get assigned to Server Job Queues 302 before any Priority 1 job is assigned. This is a reasonable interpretation of priorities, but if there's a constant stream of Priority 0 tasks, Priority 1 get “starved”. They languish and are never processed. So taking a queue cue from how Quality of Service optimization is often implemented in networks, in this preferred implementation, we employ a “modified deficit weighted round robin” approach.

For this, we begin by giving each category in Priority Categories 301 a permanent weighting, called an “Allowance”. Allowance numbers could be manually selected in advance, and unchangeable, or they could be allowed to fluctuate depending on a metric of “fairness” that measures how often lower priority jobs are given a turn. They are set so that more urgent priority jobs have larger allowances, and thus can “buy” more server time, but lower priority jobs are not set to zero—they still get some allowance to spend. In this example, arbitrarily, Priority 0 has an allowance of 100, Priority 1 has an allowance of 50, and Priority 2 has an allowance of 40.

At the start of every cycle (before some job is removed from some priority category and assigned to some server queue), each of the Priority Job Categories 301 gets its allowance added to its credit.

Finally, every job is given a “cost” that relates to its estimated time to completion, which is factor of its Job Size, Job Resource Usage, and Job Type. For example, Job A has a cost of 50.

Cycle 1 Considering P0

Every priority category gets its once-per-cycle allowance. So now P0 has a credit of 100, P1 has a credit of 50, and P2 has a credit of 40.

Using a round robin approach, every cycle we consider each priority category in order. First we consider the highest priority, P0, then P1, and finally P2.

So we begin by considering P0. Build a List L of Affordable Jobs. That priority category has a credit of 100, so we can afford Job A (50), cannot afford job B (120), and can afford Job C (100). The List L of Affordable Jobs is A, C.

Sort the List L of Affordable Jobs in ascending order of Job Requested End Time as noted in its Quality of Service information. When there is a tie, sort by the lowest job cost. Job A wants to be completed August 7 at 4 pm, and Job C wants to be completed August 7 at 10 am, so Job C goes first.

For every Job X in the List of Affordable Jobs:
Make a list of servers L.
Remove servers from Server List L that do not have the resource requirements matching Job Resource Usage in Job X's Quality of Service.
Remove severs from Server List L whose estimated time of next availability (this is a measure of how long it will take to process its entire current queue) is sooner than the job's stated Job Start Time. Don't queue the job to begin before it's ready!
Go through the servers on Server List L and find Server S, the one with the soonest estimated time of completion for Job X. To calculate this, take each server's time of next availability and add Job X's estimated computing time needed (taken from the “Job Size” in its Quality of Service description), divided by the estimated speed of that server.
Compare the estimated time of completion for Job X on Server S against Job X's Job Requested End Time. If the Job can be completed before its Job Requested End Time, then add Job X to the queue for Server S.
If Server S cannot complete Job X before its Job Requested End Time, then either reject Job X entirely and or wedge it in anyway. Report the failure or delay back to Job X's client, who may choose to abandon the job, increase its priority, or accept the missed deadline. Or there may be a sliding scale of how to handle certain failure states already given in the job's Quality of Service description.

If some Job X was assigned to some Server S, then this cycle is complete.

If no Job X was assigned to any Server S, then continue the round robin. Consider P1, build a new List L of Affordable Jobs, and then if necessary consider P2 and so forth.

In this case, having already noticed that Job C should go first, we compare Job C against all the servers. Server S0 has no queue, so it is ready to begin processing immediately, and that's okay because Job C is ready immediately also. Server S0 is the fastest, so its time for completion for Job C is the shortest, just 2 hours. We place Job C onto the queue for Server S0.

Having spent all its credit (100) to place Job C (costing 100), Priority Category P0 cannot afford to place any more jobs, so we continue in round robin fashion to consider priority category P1.

Cycle 1 Considering P1

With 50 credits to spend, the List L of Affordable Jobs for P1 is only Job D. Costing 150, Job E is too “expensive” right now.
Let's say that Job D is not a match for Server S2 because Server S1 does not have the resource requirements requested in Job D's Quality of Service description, for example a special GPU processor or extra memory.
Let's say that Job D has a Job Requested End Time of two hours from now. Therefore, Job D is not a match for Server S0 because and Server S0 will be busy with Job C for an estimated 2 hours, and thus wouldn't even be available to begin Job D until then.
Fortunately, Job D can be matched to Server S1 and is scheduled there, with an estimated job completion time of 1.5 hours from now.

Priority category P1 cannot afford to place any more jobs, so we continue in round robin fashion to considering priority category P2.

Cycle 1 Considering P2

Continuing to FIG. 3B., with 20 credits to spend, P2 cannot afford to place either Job F or G right now. We are ready to begin a new cycle.

Cycle 2

A new cycle begins. Each priority category is given its allowance.

With 100 credits to spend, P0 can afford to schedule Job A. Job A's estimated time of completion is:
4 hours from now on Server S0 (run time of 2 hours+a 2-hour queue)
5.5 hours from now on Server S1 (run time of 4 hours+1.5-hour queue)
8 hours from now on Server S2 (run time of 8 hours+0-hour queue)

So priority category P0 spends 50 credits to place Job A onto Server S0. P0 cannot afford to place any more jobs, so in round robin fashion, we move on.

Priority category P1 and P2 cannot afford to place anything to we move on to Cycle 3.

Cycle 3

A new cycle begins. Each priority category is given its allowance.

Considering P0, with a credit of 150 it can afford to place Job B. Job B's estimated time of completion is:
5 hours from now on Server S0 (run time of 1 hours+a 4-hour queue)
3.5 hours from now on Server S1 (run time of 2 hours+1.5-hour queue)
4 hours from now on Server S2 (run time of 4 hours+0-hour queue)

So Job B is placed onto Server S1.

Priority category P1 cannot afford to place anything. Priority category P2 places Job F onto Server S2 because the queues are too long for S0 and S1, even though S2 is the slowest machine.

### Preempting a Job in Process

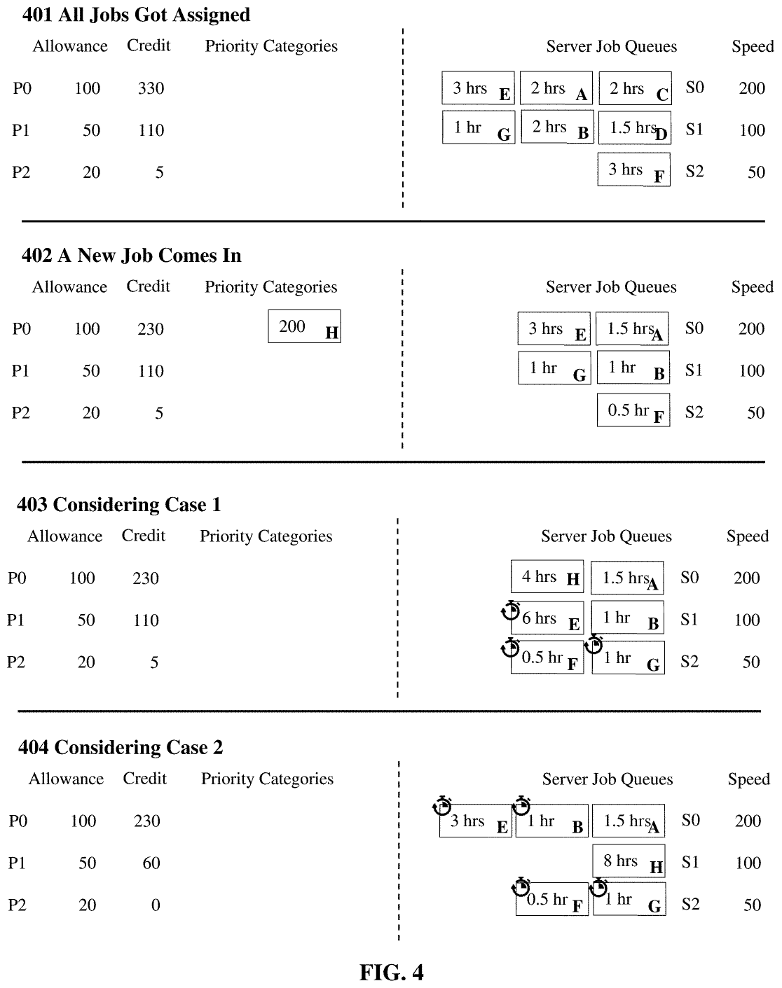

FIG. 4 shows an example of deciding whether to preempt a job.

To finish the example in FIG. 3., after Cycle 4, 5, and 6, All Jobs Got Assigned 401. After 2.5 hours of processing time, Jobs C and D are completed, and Jobs A, B, and F are partially completed.

Then a New Job Comes In 402, Job H, which is placed into priority category P0.

Job H's estimated time of completion is:
8.5 hours from now on S0 (run time of 4 hours+a 4.5-hour queue)
10 hours from now on S1 (run time of 8 hours+2-hour queue)
16.5 hours from now on S2 (run time of 16 hours+0.5-hour queue)

Unfortunately, we need H in 8 hours, according to the Job Requested End Time in its Quality of Service information. This might be possible if we preempted Job E or Job A from Server S0, or preempted both Jobs G and B from Server S1. For every server queue, we use a weighted scoring system that compares:
How badly would Job H run past its Job Requested End Time, and what level of pain is associated with that, with its priority taken into account?
If rescheduled, how badly would any preempted jobs run past their Job Requested End Time, and what level of pain is associated with that, with their priorities taken into account?
Then in a depth-first search nesting iteration, can we handle any preempted jobs by preempting other jobs?

Case 1. Considering pre-empting Job E, the best place to put Job E would be onto Server S1, where it could finish in 8 hours (1 hour of Job B remains, plus 1 hour of Job G, plus 6 hours of Job E on the slower server). In a nested iteration, there is no reason to try to preempt Job B (Priority P0) to favor Job E (Priority P1), but Job E could preempt the lower priority Job G (Priority P2), moving it to Server S2. In a second nested iteration, Job F has no urgent Job Requested End Time, so there is zero pain to preempting Job F and putting Job G foremost.

Case 2. Considering pre-empting Jobs G and B,
The best place to put Job B would be onto Server S0, to be completed 5.5 hours from now. (The remaining 1.5 hours from Job A, the 3 hours from Job E, and Job B needing to restart, but running faster in just 1 hour.) In a nested iteration, since Job B (Priority P0) is higher priority than Job E (Priority P1), Job E could be preempted, moved to the end of the queue on Server 0.
The best place to put Job G would be on Server S2, to be completed 2.5 hours from now (after Job F, and then Job G running slower). In a nested iteration, Job F has no urgent Job Requested End Time, so there is zero pain to preempting Job F and putting Job G foremost. We expect to finish Job G in 2 hours, the 1 hour remaining for Job B and the 1 hour remaining for Job G, on Server S1.

In one example, since Job B is a Priority 0 job, delaying it 1.5 hours in Case 2, just to save Job E, a Priority 1 job, a delay of 1.5 hours (the difference for Job E's expected complete time between Case 1 and Case 2) is not considered worth it, so we choose Case 1, because it does not preempt Job B.

In another example, if Job B has plenty of time remaining before its Job Requested End Time, but Job E doesn't, Case 2 may be preferred.

In another example, if the client for Job B has paid extra to guarantee that Job B will never be preempted, and thus to finish as quickly as possible, Case 2 would not be permitted, and thus Case 1 would be preferred.

In yet another example, Job H could be rejected altogether if the weighted score for preempting other jobs is just too costly.

### Determining Prices Automatically in a Bidding System

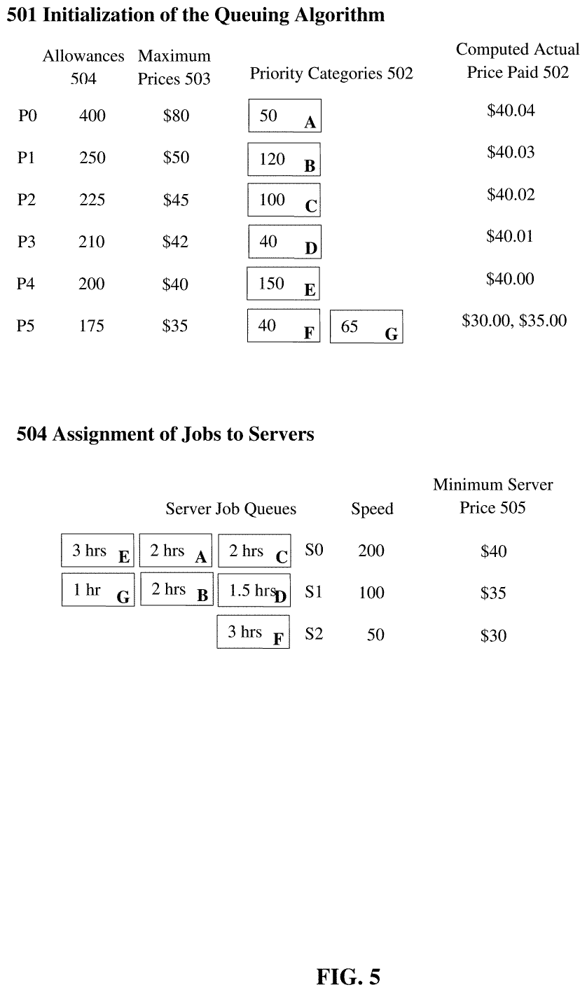

FIG. 5 shows an example of setting prices in a bidding system.

During Initialization 501 of the queuing algorithm, Jobs A, B, C, D, E, F, and G are placed into Priority Categories 502 based on the Maximum Prices 503 they are willing to pay, as designated in their Quality of Service information, rather than a requested priority in the Quality of Service information. In this case, that results in 6 different priority categories.

In FIG. 3., we introduced calculating a “computing cost” for every job. This calculation of cost is essentially a one-dimensional estimate of computing power, which relates primarily to computing speed, but also to resources including but not limited to available memory, bandwidth, and specialized hardware such as a GPU. This heuristic for measuring computing power can be used as the unit of “price”. For example, Job A is given a “computing cost” of 50, and is willing to pay a maximum price of $80 per unit of computing cost. So the client owning Job A can expect to pay at most $4,000 for computing Job A.

Each server will have a differing Minimum Server Price 505. These are set by the owners of each private server farm, and may vary over time. Of course, a faster server may charge more.

In the queuing algorithm, Allowances 504 could be automatically adjusted relative to the stated Maximum Prices 503. Price would be added to the queuing algorithm as a constraint. In other words, Job J would never be assigned to a Server S if the maximum price of Job J is lower than the minimum price of Server S. When deciding which Server S is best for Job J, lowest pricing and fastest time to completion could be combined through a scoring system to make decisions, rather than just using fastest time to completion alone. How much it's worth to each job to finish quickly could be communicated through its Quality of Service.

Let's say hypothetically that Jobs Servers A, B, C, D, E, F, and G are assigned to Servers S0, S1, and S0 and shown in Assignment of Jobs to Servers 504.

One the assignment is done, pricing is calculated in the following manner:
Sort all the queued jobs by pricing category, from lowest to highest
For each Job J, its price is the highest of:
   The minimum price for the Server S that it's queued for
   One penny more than the price paid by the Job K one priority level down.

In this example:
Job F and G are the lowest priority. There is nothing lower, so their prices are simply set to the minimum price for the servers they are queued for. So F's price is set to $30 and G's price is set to $35.
Job E is the next highest priority. One penny higher than the previous priority category would be $35.01, but Job E is running on Server S0 with Minimum Server Price 505 of $40. So Job E pays $40.
Job D is the next highest priority. One penny higher than the previous priority category would be $40.01, which is higher than the Minimum Server Price 505 of S1, so it stays.
Job C would either be $40.02 or $40. It pays $40.02.
Job B would either be $40.03 or $35. It pays $40.03.
Job A would then pay $40.04.

Of course, an implementation of this invention would not necessarily be so generous. The incremental rise in pricing between priority categories could be set to $1.00 instead of $0.01, or each job's price could have a floor requiring the client pays at least 80% of its maximum price.

A server with an empty queue could, by permission with the owner of the private server farm, as communicated in the Quality of Service description for its servers, automatically have its pricing temporarily lowered, which might trigger jobs to move from one server to another. The owner of a private server farm, with resources it prefers to reserve for itself, may offer that additional capacity when offered a higher price, as communicated in the Quality of Service description for its server.

Pricing signals could also be turned into recommendations that the owner of a private server farm raise prices, lower prices, shed hardware that lacks sufficient resources, or purchase new hardware.

What is claimed is:

1. A method of assigning large computational tasks to servers within an aggregated cloud service with limited capacity and nonhomogeneous servers with differing resources and capacities, the method comprising the steps of:
submitting, by a client, each job to be computed with Quality of Service information at least a priority;
providing each server in the aggregated cloud service with Quality of Service information that may include at least resource type and/or capacity;
at a centralized Global Task Manager:
receiving job requests from clients;
receiving resource type and/or capacity information from the servers;
assigning jobs to the servers using an algorithm;
coordinating the submission of each job to its assigned server; and
coordinating the deliver of results back to the client.

2. The method as in claim 1 further comprising:
at one or more job queues for each server, specifying an order in which jobs are to be processed; and
the Global Task Manager further placing jobs into server job queues rather than giving them directly to the servers.

3. The method as in claim 2 further comprising:
providing a multilevel queuing algorithm for the Global Task Manager, based on a deficit weighted round robin approach, modified to optimize the nonhomogeneous nature of the servers in the aggregated cloud service, to optimize use of capacity and rapid times of completion.

4. The method as in claim 1 further comprising:
at a Local Task Manager in each private server farm of the aggregated cloud service,
updating the Quality of Service information about each server monitoring jobs in progress, and
updating each job's estimated time of completion.

5. The method of claim 1 wherein the Quality of Service may contain a requested completion time for the job, to be used by the Global Task Manager in assigning jobs to server queues.

6. The method of claim 1 further comprising:
allowing the Quality of Service information to specify how a job may be subdivided into two or more subjobs, to be used by the Global Task Manager in assigning jobs.

7. The method of claim 1 further compromising:
allowing the Quality of Service information to specify a price rather than a priority, to be used by the Global Task Manager in assigning jobs to servers.

8. The method of claim 7 further comprising:
bidding for access, where a price maximum set in each job's Quality of Service information is matched with a price minimum in each server's Quality of Service information, and
establishing an actual price through an algorithm.

9. The method of claim 8 further comprising:
computing the actual price paid by each job, based on sorting jobs by priority, and then
charging each job:
marginally more than the job just below it in priority;
or, if larger, the minimum server price.

10. The method of claim 10 further comprising:
in addition to the Quality of Service for a job, allowing the client to specify a pricing reward, or a sliding scale of rewards, for a job that is completed more quickly than requested, or a pricing penalty, or a sliding scale of penalties, for a job that is completed past the requested Job Requested End Time.

11. The method of claim 2 further comprising:
allowing a new job to be forced ahead into one of the server queues by calculating and minimizing preempting of one or more jobs from their assigned positions in the server queues.

12. The method of claim 11, further comprising:
scheduling jobs via an iterative algorithm that, when a job is preempted, considers whether the job may itself be forced ahead through additional preemptions.

13. The method of claim 11 further comprising:
additionally optimizing t for types of jobs and system resources by permitting, when a running job is preempted, its entire execution state to be stored, so that the job's computation can later be restarted in progress rather than restarted from its beginning.

14. The method of claim 11 further comprising:
in an addition to the Quality of Service for a job, allowing the client to offer an additional payment for a promise that its jobs will never be preempted.

15. The method of claim 1 further comprising:
monitoring a progress of each client's job(s).

16. The method as in claim 15 further comprising:
at a client, upon seeing the report of a job's expected time of completion, increasing the priority with a higher payment to save time, or decreasing the priority with a longer time of completion, to save costs.

17. The method as in claim 1 further comprising:
monitoring each owner of a private server farm in the aggregate cloud service for administrating capacity and monitoring usage.

18. The method as in claim 17 further comprising:
at the Global Task Manager, making recommendations to each owner of a private server farm in aggregated cloud service, which may include but is not limited to optimization suggestions to change pricing, capacity, or hardware.

19. The method as in claim 1 further comprising:
in an addition to the algorithm for the Global Task Manager, if the private server farms are permitted to set capacity guarantees along a set time schedule, taking those schedules into account when assigning jobs to servers.

20. The method as in claim 1 further comprising:
in an addition to the algorithm for the Global Task Manager, if the private server farms are too expensive or have no remaining capacity, permiting the Global Task Manager to send jobs to a generic, public cloud service whose pricing and capabilities are noted in its own Quality of Service description.
